(19) United States
(12) Patent Application Publication
(10) Pub. No.: US 2019/0386500 A1
(43) Pub. Date: Dec. 19, 2019

(54) PORTABLE WIRELESS CHARGING APPARATUS

(71) Applicant: I/O INTERCONNECT, LTD., Santa Ana, CA (US)

(72) Inventors: Gary KUNG, Santa Ana, CA (US); Kuei-Jung YANG, Taipei (TW)

(21) Appl. No.: 16/007,216

(22) Filed: Jun. 13, 2018

(51) Int. Cl. H02J 7/00; H02J 7/02

(52) U.S. Cl. CPC H02J 7/0044; H04M 1/0202; H02J 7/025

(57) ABSTRACT

A portable wireless charging apparatus includes a housing, an elastic adhesive member, a pushing member, and a wireless charging module. The housing includes a top board and has an interior space therein. The top board has an opening connected to the interior space. The elastic adhesive member is disposed in the interior space. The pushing member is disposed in the interior space and configured to push the elastic adhesive member toward the opening, so as to make a portion of the elastic adhesive member protrude out of the housing via the opening. The wireless charging module is disposed in the interior space and configured to charge an electronic device placed over the top board.

### BACKGROUND

### Technical Field

The present disclosure relates to a portable wireless charging apparatus.

### Description of Related Art

As the wireless charging technology matures and the charging efficiency improves, more portable electronic devices, such as, mobile phone, personal video player, digital camera, and so on, use wireless charging. The above electronic devices use a built-in receiving induction coil electrically connected to the battery, and a wireless charging apparatus is disposed with a built-in transmitting induction coil. When the transmitting and the receiving induction coils get close, the energy can be propagated according to the electromagnetic effect and electromagnetic resonance effect. After the electricity power transformation, the battery of the electronic device can be charged.

The conventional wireless charging apparatus often includes a power cord and a wireless charging pad. The wireless charging pad is for placing a wirelessly chargeable electronic device upon, and the power cord can be plugged into a socket through the plug at the end of the power cord. As such, the charging is performed through electromagnetic effect. Although convenient, the charging often must be conducted on a flat surface, such as a desk top, or some stable places devoid of shaking or swinging. Such wireless charging apparatus is often unsuitable for a mobile phone to stand in a tilt position or charging inside a moving vehicle. Therefore, the convenience issue must be re-addressed.

### SUMMARY

An aspect of the disclosure is to provide a portable wireless charging apparatus capable of fixing electronic devices during charging.

According to an embodiment of the disclosure, a portable wireless charging apparatus includes a housing, an elastic adhesive member, a pushing member, and a wireless charging module. The housing includes a top board and has an interior space therein. The top board has an opening connected to the interior space. The elastic adhesive member is disposed in the interior space. The pushing member is disposed in the interior space and configured to push the elastic adhesive member toward the opening, so as to make a portion of the elastic adhesive member protrude out of the housing via the opening. The wireless charging module is disposed in the interior space and configured to charge an electronic device placed over the top board.

In an embodiment of the disclosure, the portable wireless charging apparatus further includes a control circuit board electrically connected to the wireless charging module and the pushing member. The control circuit board drives the pushing member to push the elastic adhesive member when the wireless charging module establishes an inductive coupling with the electronic device.

In an embodiment of the disclosure, the control circuit board drives the pushing member to leave the elastic adhesive member when the inductive coupling between the wireless charging module and the electronic device is removed.

In an embodiment of the disclosure, the housing further includes a side board. The side board is connected to an edge of the top board and has an insertion port. The control circuit board has an electrical connector at the insertion port.

In an embodiment of the disclosure, the portable wireless charging apparatus further includes a battery electrically connected to the control circuit board.

In an embodiment of the disclosure, the pushing member is an electromagnetic valve.

In an embodiment of the disclosure, the pushing member includes a push pin, a micro switch, and a position recovery member. The push pin is configured to push the elastic adhesive member. The micro switch is electrically connected to the control circuit board and configured to apply a first force to move the push pin toward the opening of the top board. The position recovery member is connected to the push pin and configured to apply a second force to move the push pin away from the opening. The second force is smaller than the first force.

In an embodiment of the disclosure, the position recovery member is a compression spring compressed by the push pin and the micro switch.

In an embodiment of the disclosure, the housing further includes a bottom board opposite to the top board. The micro switch is connected to the bottom board.

In an embodiment of the disclosure, the elastic adhesive member includes a first film portion and a second film portion. The first film portion is connected to the housing. The second film portion is surrounded by the first film portion, recessed away from the push member, and protruded toward the opening of the top board. The pushing member is configured to push the second film portion.

In an embodiment of the disclosure, the second film portion includes a curved part and a flat part. The curved part is connected to and surrounded by the first film portion. The flat part is connected to and surrounded by the curved part.

In an embodiment of the disclosure, the top board has a corner, and the opening of the top board is proximal to the corner.

In an embodiment of the disclosure, the portable wireless charging apparatus further includes a shielding member. The shielding member is slidably disposed in the interior space and configured to shield between the opening of the top board and the elastic adhesive member.

In an embodiment of the disclosure, the portable wireless charging apparatus further includes a sliding member. The sliding member is slidably engaged with the housing, operatively connected to the shielding member, and configured to move between a first position and a second position relative to the housing. When the sliding member slides to the first position, the shielding member covers the opening of the top board. When the sliding member slides to the second position, the shielding member exposes the opening.

Accordingly, the portable wireless charging apparatus of the disclosure can fix an electronic device on the top board of the housing by protruding a portion of the elastic adhesive member above the top board via its opening, so as to adhere the electronic device during charging. Furthermore, the elastic adhesive member can be automatically protruded when the wireless charging module establishes an inductive coupling with the electronic device. After the charging is finished, the elastic adhesive member can be automatically returned in the housing. In addition, the portable wireless charging apparatus of the disclosure use the shielding member to shield the opening of the top board, so as to prevent dust or liquid from entering the housing to pollute the elastic adhesive member and thus decrease its adhesion ability.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1A is a perspective view illustrating a first operating state of a portable wireless charging apparatus according to some embodiments of the disclosure;

FIG. 1B is an exploded view of the portable wireless charging apparatus shown in FIG. 1A according to some embodiments of the disclosure;

FIG. 2 is a partial cross-sectional view of the portable wireless charging apparatus shown in FIG. 1A taken along line 2-2 according to some embodiments of the disclosure;

FIG. 3 is a perspective view illustrating a second operating state of the portable wireless charging apparatus shown in FIG. 1A according to some embodiments of the disclosure;

FIG. 4 is a partial cross-sectional view of the portable wireless charging apparatus shown in FIG. 3 taken along line 4-4 according to some embodiments of the disclosure;

FIG. 5 is a perspective view illustrating the portable wireless charging apparatus in FIG. 1A fixing a mobile phone according to some embodiments of the disclosure;

FIG. 6A is a perspective view of a portable wireless charging apparatus according to some embodiments of the disclosure, in which a shielding member in the housing exposes openings of a top board;

FIG. 6B is another perspective view of the portable wireless charging apparatus shown in FIG. 6A according to some embodiments of the disclosure, in which the shielding member shields the openings of the top board; and

FIG. 7 is a partial cross-sectional view of the portable wireless charging apparatus shown in FIG. 6A taken along line 7-7 according to some embodiments of the disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts. However, specific structural and functional details disclosed herein are merely representative for purposes of describing example embodiments, and thus may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope of the disclosure.

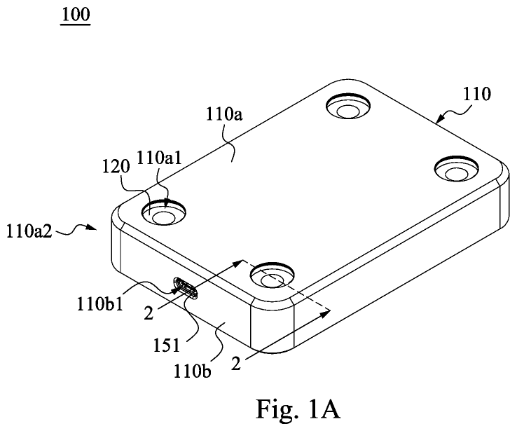

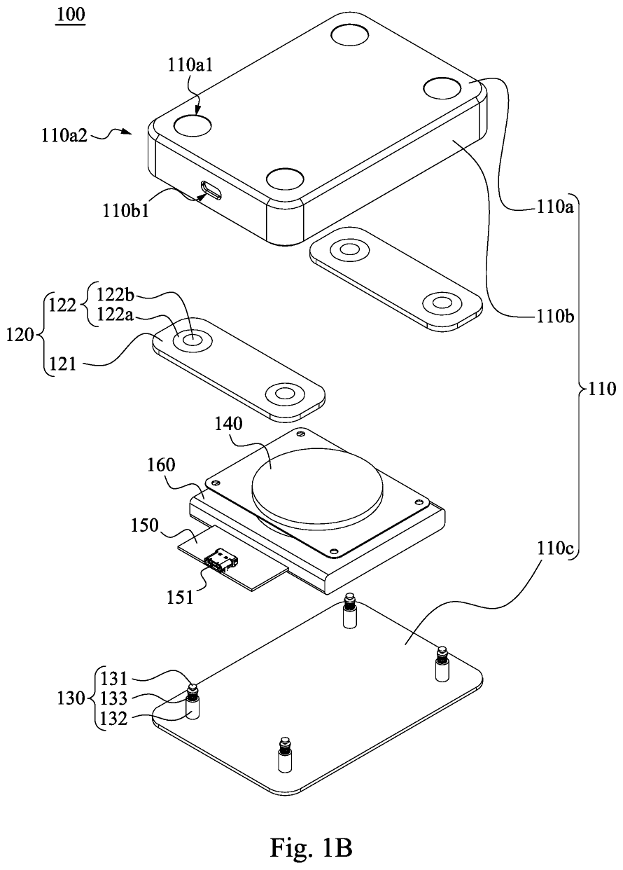

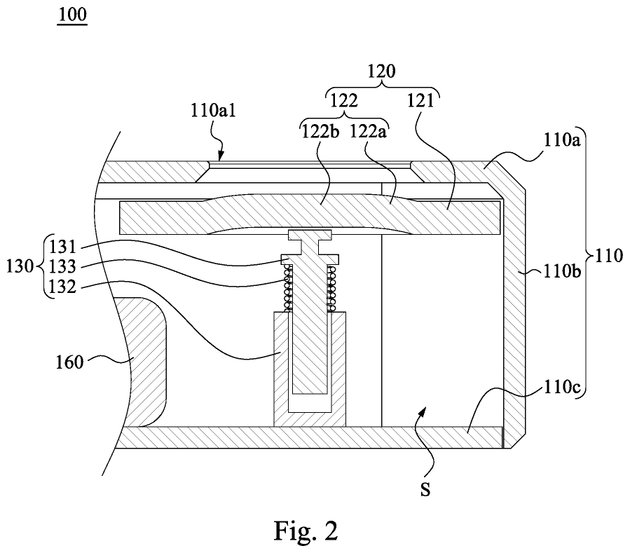

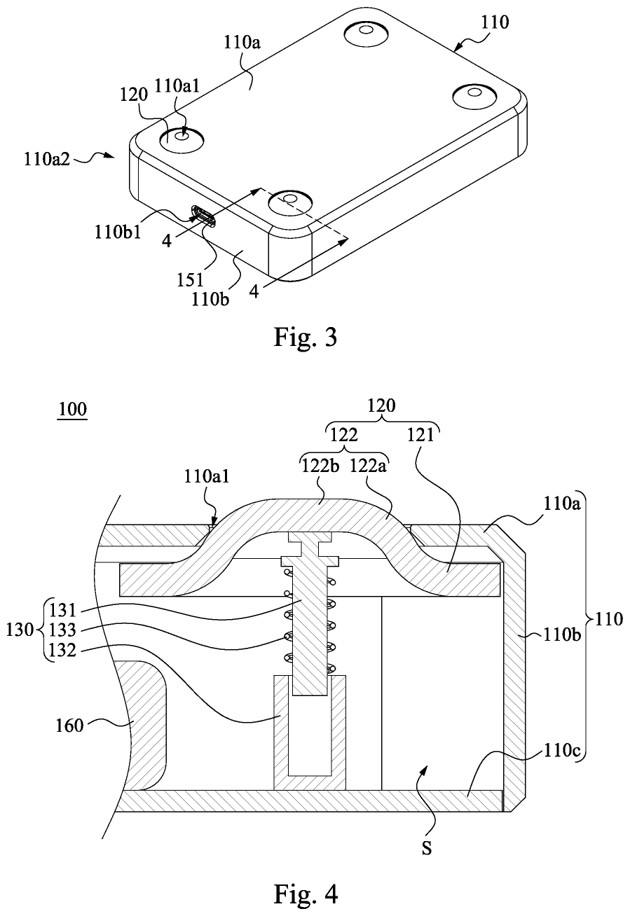

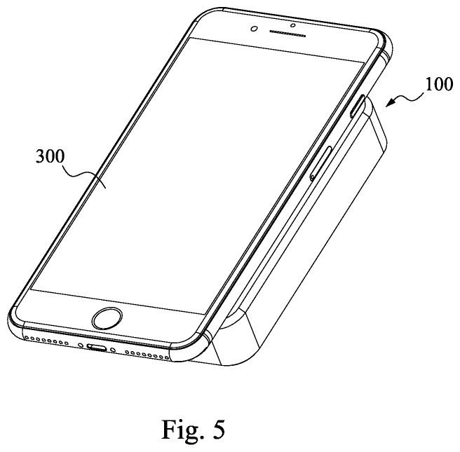

Reference is made to FIGS. 1A-5. FIG. 1A is a perspective view illustrating a first operating state of a portable wireless charging apparatus 100 according to some embodiments of the disclosure. FIG. 1B is an exploded view of the portable wireless charging apparatus 100 shown in FIG. 1A according to some embodiments of the disclosure. FIG. 2 is a partial cross-sectional view of the portable wireless charging apparatus 100 shown in FIG. 1A taken along line 2-2 according to some embodiments of the disclosure. FIG. 3 is a perspective view illustrating a second operating state of the portable wireless charging apparatus 100 shown in FIG. 1A according to some embodiments of the disclosure. FIG. 4 is a partial cross-sectional view of the portable wireless charging apparatus 100 shown in FIG. 3 taken along line 4-4 according to some embodiments of the disclosure. FIG. 5 is a perspective view illustrating the portable wireless charging apparatus 100 in FIG. 1A fixing a mobile phone according to some embodiments of the disclosure. Structures and functions of components included in the portable wireless charging apparatus 100 and connection relationships among the components will be described in detail below.

It should be pointed out that numbers of the openings 110a1 of the top board 110a, the elastic adhesive members 120, and the pushing members 130 shown in FIGS. 1A and 1B are only an example and should not be construed as limited to only example embodiments set forth herein.

As shown in FIGS. 1A and 1B, in some embodiments, the portable wireless charging apparatus 100 includes a housing 110, elastic adhesive members 120 (only one of which is labelled with reference number), pushing members 130 (only one of which is labelled with reference number), and a wireless charging module 140. The housing 110 includes a top board 110a and has an interior space S therein. The top board 110a has openings 110a1 (only one of which is labelled with reference number) connected to the interior space S. The elastic adhesive members 120 are disposed in the interior space S. The pushing members 130 are disposed in the interior space S and configured to push the elastic adhesive members 120 toward the openings 110a1, so as to make portion of the elastic adhesive members 120 protrude out of the housing 110 via the openings 110a1 The wireless charging module 140 is disposed in the interior space S and configured to charge an electronic device 300 (e.g., a mobile phone 300 in FIG. 5) placed over the top board 110a.

As show in FIG. 1B, the portable wireless charging apparatus 100 further includes a control circuit board 150 electrically connected to the wireless charging module 140 and the pushing members 130. The control circuit board 150 automatically drives the pushing members 130 to push the elastic adhesive members 120 when the wireless charging module 140 establishes an inductive coupling with the electronic device 300. In some embodiments, the control circuit board 150 automatically drives the pushing member 130 to leave the elastic adhesive member 120 when the inductive coupling between the wireless charging module 140 and the electronic device 300 is removed. Therefore, the portable wireless charging apparatus 100 of such embodiments can fix the electronic device 300 on the top board 110a of the housing 110 by protruding the portions of the elastic adhesive members 120 above the top board 110a via the openings 110a1, so as to adhere the electronic device 300 during charging.

In some embodiments, the elastic adhesive members 120 can be made of materials such as PU Gel (Polyurethane Gel Elastomer), but the disclosure is not limited in this regard.

As shown in FIGS. 1A and 1B, in some embodiments, the housing 110 further includes a side board 110b. The side board 110b is connected to a peripheral edge of the top board 110a and has an insertion port 110b1. The control circuit board 150 has an electrical connector 151 at the insertion port 110b1. The portable wireless charging apparatus 100 further includes a battery 160 electrically connected to the control circuit board 150. The control circuit board 150 is configured to manage the power transmitted from the electrical connector 151 to the battery 160 and the power transmitted from the battery 160 to the wireless charging module 140.

As shown in FIGS. 2 and 4, in some embodiments, at least one of the pushing members 130 is an electromagnetic valve. Specifically, the pushing member 130 includes a push pin 131, a micro switch 132, and a position recovery member 133. The push pin 131 is configured to push the elastic adhesive member 120. The micro switch 132 is electrically connected to the control circuit board 150. When the wireless charging module 140 establishes the inductive coupling with the electronic device 300, the control circuit board 150 automatically drive the micro switch 132 to apply a first force to move the push pin 131 toward the opening 110a1 of the top board 110a. The position recovery member 133 is connected to the push pin 131 and configured to apply a second force to move the push pin 131 away from the opening 110a1. The second force is smaller than the first force.

In some embodiments as shown in FIGS. 2 and 4, the position recovery member 133 is a compression spring compressed by the push pin 131 and the micro switch 132. As such, the second force generated by the position recovery member 133 is a variable force. In some other embodiments, the position recovery member 133 is a tension spring stretched by the push pin 131 and the micro switch 132.

In some embodiments as shown in FIGS. 1B, 2 and 4, the housing 110 further includes a bottom board 110c opposite to the top board 110a. The micro switch 132 is disposed on the bottom board 110c, but the disclosure is not limited in this regard.

In some embodiments as shown in FIGS. 1B, 2, and 4, each of the elastic adhesive members 120 includes a first film portion 121 and two second film portions 122, but the disclosure is not limited in this regard. The first film portion 121 is connected to the housing 110. For example, a peripheral part the first film portion 121 is fixed to an inner surface of the top board 110a or the side board 110b, but the disclosure is not limited in this regard. Each of the second film portions 122 is surrounded by the first film portion 121, recessed away from a corresponding one of the push members, and protruded toward a corresponding one of the openings 110a1 of the top board 110a. Each of the pushing members 130 is configured to push a corresponding one of the second film portions 122. As such, the second film portions 122 of the elastic adhesive members 120 are protruded out of the openings 110a1 of the top board 110a after the pushing, such that the second film portions 122 are configured to adhere and thus fix the electronic device 300. The preformed second film portions 122 can concentrate the deformation of the elastic adhesive members 120 in advance and reduce the influence on the first film portion 121 caused by the deformation.

Specifically, one of the second film portions 122 includes a curved part 122a and a flat part 122b. The curved part 122a is connected to and surrounded by the first film portion 121. The flat part 122b is connected to and surrounded by the curved part 122a. That is, the curved part 122a is ring-shaped and connected at an inner edge of the first film portion 121, and the flat part 122b is connected in an inner edge of the curved part 122a. Each of the pushing members 130 is configured to push the flat part 122b of the corresponding one of the second film portions 122. The flat part 122b can increase total area of contacting and thus the adhesion between the deformed elastic adhesive member 120 and the electronic device 300.

In some embodiments as shown in FIG. 1A, the top board 110a has four corners 110a2, and the openings 110a1 of the top board 110a are proximal to the corners 110a2 respectively. As such, even if the elastic adhesive members 120 are still adhered to the electronic device 300 after the pushing members 130 are returned into the housing 110, the electronic device 300 can be easily peeled off from the elastic adhesive members 120 due to the locations of the openings 110a1.

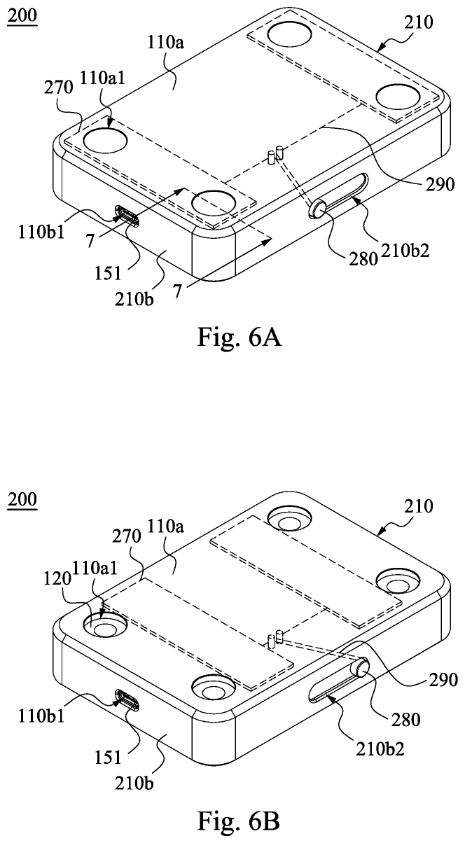

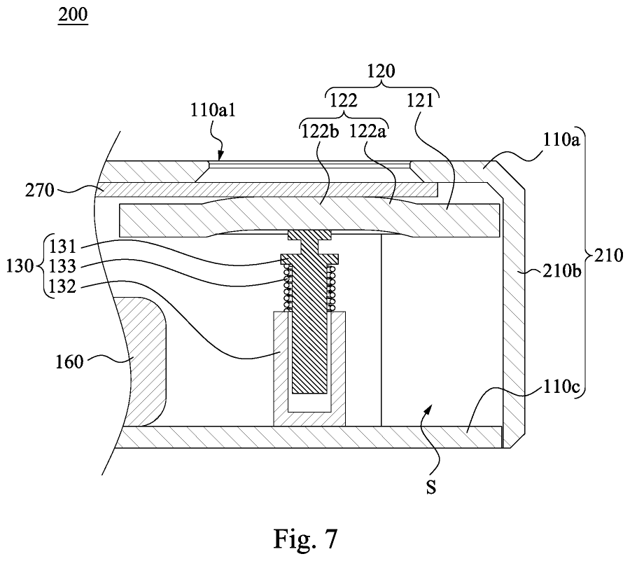

Reference is made to FIGS. 6A, 6B, and 7. FIG. 6A is a perspective view of a portable wireless charging apparatus 200 according to some embodiments of the disclosure, in which a shielding member 270 in the housing 210 exposes the openings 110a1 of the top board 110a. FIG. 6B is another perspective view of the portable wireless charging apparatus 200 shown in FIG. 6A according to some embodiments of the disclosure, in which the shielding member 270 shields the openings 110a1 of the top board 110a. FIG. 7 is a partial cross-sectional view of the portable wireless charging apparatus 200 shown in FIG. 6A taken along line 7-7 according to some embodiments of the disclosure.

As shown in FIGS. 6A, 6B, and 7, in some embodiments, the portable wireless charging apparatus 200 includes a housing 210, elastic adhesive members 120 (only one of which is labelled with reference number), pushing members 130 (only one of which is labelled with reference number), a wireless charging module 140 (not shown, but can be referred to the embodiment of FIG. 1B), shielding members 270, a sliding member 280, and connection members 290, in which the housing 210, the elastic adhesive members 120, the pushing members 130, and the wireless charging module 140 are substantially similar to those of the embodiments in FIGS. 1A and 1B respectively, so descriptions of these components can be referred to above related contents and therefore do not repeated here for simplicity.

It should be pointed out that in the embodiments shown in FIGS. 6A, 6B, and 7, the shielding members 270 is slidably disposed in the interior space S and configured to shield between the opening 110a1 of the top board 110a and the elastic adhesive members 120. For example, guiding structures (not shown) can be located at the inner surface of the top board 110a to guide the shielding members 270 to slide relative to the top board 110a. As such, the portable wireless charging apparatus 200 can use the shielding member 270 to shield the openings 110a1 of the top board 110a, so as to prevent dust or liquid from entering the housing 210 to pollute the elastic adhesive member 120 and thus decrease its adhesion ability. In addition, the shielding member 270 can also be used to prevent the components in the housing 210 (e.g., the wireless charging module 140, the control circuit board 150, and the battery 160) from damages caused by dust or liquid.

In some embodiments, the side board 110b of the housing 210 has a slotted hole 210b2, and the sliding member 280 is slidably engaged with the slotted hole 210b2 and configured to move between a first position (referring to FIG. 6A) and a second position (referring to FIG. 6B) relative to the housing 210. The sliding member 280 is operatively connected to the shielding member 270 through the connection members 290. When the sliding member 280 slides to the first position, the shielding members 270 cover the openings 110a1 of the top board 110a. When the sliding member 280 slides to the second position, the shielding members 270 expose the openings 110a1. In some embodiments, the connection members 290 are ropes, so that the sliding member 280 can move the shielding members 270 through the connection members 290 to expose the openings 110a1. In some embodiments, additional components similar to the position recovery member 133 can be disposed in the housing 210 and configured to move the shielding members 270 to cover the openings 110a1.

According to the foregoing recitations of the embodiments of the disclosure, it can be seen that the portable wireless charging apparatus of the disclosure can fix an electronic device on the top board of the housing by protruding a portion of the elastic adhesive member above the top board via its opening, so as to adhere the electronic device during charging. Furthermore, the elastic adhesive member can be automatically protruded when the wireless charging module establishes an inductive coupling with the electronic device. After the charging is finished, the elastic adhesive member can be automatically returned in the housing. In addition, the portable wireless charging apparatus of the disclosure use the shielding member to shield the opening of the top board, so as to prevent dust or liquid from entering the housing to pollute the elastic adhesive member and thus decrease its adhesion ability.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A portable wireless charging apparatus, comprising:
a housing comprising a top board and having an interior space therein, wherein the top board has an opening connected to the interior space;
an elastic adhesive member disposed in the interior space;
a pushing member disposed in the interior space and configured to push the elastic adhesive member toward the opening, so as to make a portion of the elastic adhesive member protrude out of the housing via the opening; and
a wireless charging module disposed in the interior space and configured to charge an electronic device placed over the top board.

2. The portable wireless charging apparatus of claim 1, further comprising:
a control circuit board electrically connected to the wireless charging module and the pushing member, wherein the control circuit board drives the pushing member to push the elastic adhesive member when the wireless charging module establishes an inductive coupling with the electronic device.

3. The portable wireless charging apparatus of claim 2, wherein the control circuit board drives the pushing member to leave the elastic adhesive member when the inductive coupling between the wireless charging module and the electronic device is removed.

4. The portable wireless charging apparatus of claim 2, wherein the housing further comprises a side board connected to an edge of the top board having an insertion port, and the control circuit board has an electrical connector at the insertion port.

5. The portable wireless charging apparatus of claim 2, further comprising:
a battery electrically connected to the control circuit board.

6. The portable wireless charging apparatus of claim 2, wherein the pushing member is an electromagnetic valve.

7. The portable wireless charging apparatus of claim 6, wherein the pushing member comprises:
a push pin configured to push the elastic adhesive member; and
a micro switch electrically connected to the control circuit board and configured to apply a first force to move the push pin toward the opening of the top board; and
a position recovery member connected to the push pin and configured to apply a second force to move the push pin away from the opening, wherein the second force is smaller than the first force.

8. The portable wireless charging apparatus of claim 7, wherein the position recovery member is a compression spring compressed by the push pin and the micro switch.

9. The portable wireless charging apparatus of claim 7, wherein the housing further comprises a bottom board opposite to the top board, and the micro switch is connected to the bottom board.

10. The portable wireless charging apparatus of claim 1, wherein the elastic adhesive member comprises:
a first film portion connected to the housing; and
a second film portion surrounded by the first film portion, recessed away from the push member, and protruded toward the opening of the top board, wherein the pushing member is configured to push the second film portion.

11. The portable wireless charging apparatus of claim 10, wherein the second film portion comprises:
a curved part connected to and surrounded by the first film portion; and
a flat part connected to and surrounded by the curved part.

12. The portable wireless charging apparatus of claim 1, wherein the top board has a corner, and the opening of the top board is proximal to the corner.

13. The portable wireless charging apparatus of claim 1, further comprising:
a shielding member slidably disposed in the interior space and configured to shield between the opening of the top board and the elastic adhesive member.

14. The portable wireless charging apparatus of claim 13, further comprising:
a sliding member slidably engaged with the housing, operatively connected to the shielding member, and configured to move between a first position and a second position relative to the housing,
wherein when the sliding member slides to the first position, the shielding member covers the opening of the top board, and when the sliding member slides to the second position, the shielding member exposes the opening.
